(19) United States
(12) Patent Application Publication
(10) Pub. No.: US 2025/0001327 A1
(43) Pub. Date: Jan. 2, 2025

(54) WATER EMULSIONS SEPARATION SYSTEM AND PROCESS

(71) Applicant: Avonlea Technology Holdings Corp., Calgary (CA)

(72) Inventors: Douglas James Brett, MD Foothills (CA); Ronald Otto Lincz, Calgary (CA)

(73) Assignee: Avonlea Technology Holdings Corp., Calgary, AB (CA)

(21) Appl. No.: 18/695,660

(22) PCT Filed: Sep. 27, 2021
(86) PCT No.: PCT/IB2021/058805

§ 371 Date: Mar. 26, 2024

(51) Int. Cl. B01D 17/04; B01D 17/02; B01D 17/12; E21B 43/34

(52) U.S. Cl. CPC B01D 17/044; B01D 17/12; B01D 17/0205; E21B 43/34

(57) ABSTRACT

An example of a method and apparatus to carry out the method are provided. The method involves receiving a process fluid into a cavitation chamber via an inlet. The process fluid is pumped into the cavitation chamber at an inlet pressure, and includes a first component and a second component. The method further involves reducing a pressure of the process fluid in the cavitation chamber as the process fluid moves away from the inlet. The pressure is reduced from the inlet pressure to below a fluid vapor pressure to create micro-bubbles. In addition, the method involves collapsing the micro-bubbles to generate a localized energy release. The localized energy release separates the first component from the second component to form a separated fluid.

### BACKGROUND

Crude oil production generally involves extracting a mixture of oil, water, and natural gas from an underground formation. The exact composition of mixture recovered from the formation is dependent on the formation from which they are produced. The produced mixture is processed to separate the components, where by the oil and natural gas go to sales and the produced water is usually sent to disposal. The oil and water components of the produced fluid may be in the form of an emulsion. An emulsion is made up of two immiscible fluids, usually water and oil. Emulsions are composed of small droplets of one fluid (inner phase) dispersed within a continuous phase of the other fluid. Either water or oil can be the inner phase or continuous phase of the emulsion. Some emulsions may not be easily separated using traditional heat and gravity separation methods in which case de-emulsifying chemicals are added to assist with breaking emulsions and promoting phase separation.

Breaking the stability of an emulsion involves the coalescing of the very small internal phase droplets into larger droplets to a point where they are no longer dispersed within the continuous phase and separate out due to oil/water density differentials. Several chemical and physical mechanisms can impact the stability of the emulsion, impeding the desired oil/water phase separation. Some mechanisms include, interfacial films, surfactants and/or micelles which form around the internal phase droplets preventing them from coalescing and in some cases repel each other.

### BRIEF DESCRIPTION OF THE DRAWINGS

Reference will now be made, by way of example only, to the accompanying drawings in which:

FIG. 1 is a schematic representation of the components of an example of an apparatus to separate components of an emulsion;

FIG. 2 is a schematic representation of the components of another example of an apparatus to separate components of an emulsion;

FIG. 3 is a schematic representation of an example of a system to extract oil from a formation;

FIG. 4 is a schematic representation of another example of a system to extract oil from a formation;

FIG. 5 is a flowchart of an example process of separating an emulsion; and

FIG. 6 is a flowchart of an example process of extracting oil from a formation.

### DETAILED DESCRIPTION

As used herein, any usage of terms that suggest an absolute orientation (e.g. “top”, “bottom”, “up”, “down”, “left”, “right”, etc.) may be for illustrative convenience and refer to the orientation shown in a particular figure. However, such terms are not to be construed in a limiting sense as it is contemplated that various components will, in practice, be utilized in orientations that are the same as, or different than those described or shown.

The extraction and production of crude oil from an underground formation typically involves separating oil from other produced components such as gas and water Crude oil and gas is separated from the produced fluid mixture and sent to sales. The remaining produced water is sent to disposal. The separated produced water may still contain some residual crude in an emulsified state which could not be separated from the produced water using conventional separation methods.

An apparatus and method to recover residual emulsified crude from produced water is provided. The apparatus uses hydrodynamic cavitation at a level of intensity that breaks the emulsion while significantly reducing the retention time for the separation of the different phases from the emulsion. Furthermore, the reduced retention time can be further enhanced with secondary mechanisms. This apparatus may remove substantially all of any remaining liquid hydrocarbons in the process fluid (90%). In an example, the apparatus may be used either in-line or downstream of a conventional crude oil and water separation system to remove any residual emulsified crude within the produced water. Accordingly, the water component may be reused for other purposes, such as fracturing fluid or “kill” fluid, or be injected for disposal in a water disposal well or reinjected into a water flood system.

Hydrodynamic cavitation is the process where a fluid experiences a pressure drop across the hydrodynamic cavitation system. By reducing the pressure, the hydrodynamic cavitation system creates micro-bubbles in fluid caused by a rapid decrease of localized pressure in a fluid flow system. The rapid decrease of pressure to below the fluid vapor pressure of the fluid causes the fluid to vaporize in the flow. As the fluid system returns to a pressure above the fluid vapor pressure, the micro-bubbles collapse and create a very high localized energy release in the form of elevated pressures and temperatures within a very short period of time. Hydrodynamic cavitation in a controlled environment may be used to enhance chemical and physical reactions due to multiple factors which include the energy released during the collapse of the micro-bubbles, the subsequent micro-shock waves being generated, as well as the release of free radicals. In an example, hydrodynamic cavitation may be used to break the oil and water emulsion associated with the residual crude remaining in the water following initial oil and water separation efforts. Once the emulsion is broken, the residual crude oil will form a separate phase in a separation vessel.

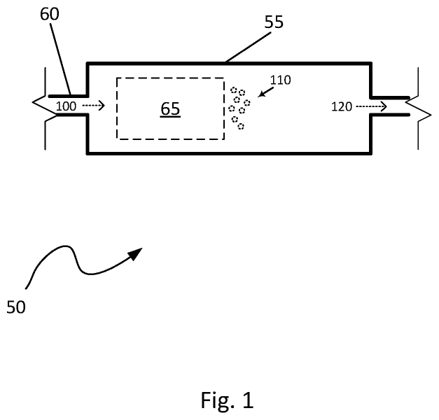

Referring to FIG. 1, a schematic representation of an apparatus to separate components of a process fluid 100 is generally shown at 50. The apparatus 50 may include additional components, such as various filters or processing devices. For example, the apparatus 50 may include flow controllers, pumps, or other mechanical features to assist with the flow of the process fluid through the apparatus 50. In other examples, the apparatus 50 may further include heaters or devices to provide for the injection of chemicals into the process fluid flow to further assist with the separation of the components in the process fluid. In the present example, the apparatus 50 includes a cavitation chamber 55, an inlet 60 from which the process fluid 100 enters the cavitation chamber 55, and a micro-bubble generator 65.

In the present example, the cavitation chamber 55 is not particularly limited and is adjustable for volume parameters. It is to be appreciated by a person of skill with the benefit of this description that the cavitation chamber 55 is not limited to any size or design. In other examples, the cavitation chamber 55 may be significantly larger for applications involving downstream processing of process fluid 100 from multiple producing oil wells. In other examples, where the apparatus 50 is to be installed in-line closer to a well head after traditional separation equipment.

In other examples, the apparatus 50 may be connected to multiple sources of process fluid, such as from multiple oil wells or storage tanks. In such examples, the multiple sources may be combined such that the process fluid is fed into the apparatus 50 in parallel, or a switching mechanism may be used so that the apparatus 50 may process the process fluid from each source in series.

The process fluid 100 entering the cavitation chamber 55 is not particularly limited and may include any liquid with multiple components mixed together to be separated. In particular, the process fluid 100 may be a suspension of different components, such as an emulsion. In the present example of a process fluid from a producing oil well, the process fluid 100 may be an emulsion containing a water component and a crude oil component. The emulsion may also include other components, such as lighter or heavier hydrocarbons.

Furthermore, the construction of the cavitation chamber 55, such as the walls is not particularly limited and may use a wide variety of materials. In the present example, the cavitation chamber 55 is steel chamber. The cavitation chamber 55 may also be lined internally with an anti-corrosion layer and include an insulating layer. In other examples, the cavitation chamber 55 may be construction from other materials, such as plastic or stainless steel. Furthermore, it is to be appreciated that in some examples, the cavitation chamber 55 may be a single unitary body constructed from the same material, such as from a molded process. In other examples, the cavitation chamber 55 may be manufacture from several pieces bolted or welded together.

The inlet 60 disposed on the cavitation chamber 55. In the present example, the inlet 60 Is disposed at an end of the cavitation chamber 55 to receive the process fluid 100 at a high pressure. The pressure at which the process fluid 100 passes through the inlet 60 is not limited. In the present example, the pressure at which the process fluid 100 enters the cavitation chamber may be about 20 psi (pounds per square inch). In other examples, the inlet pressure may be about 60 psi. In another example, the pressure may be about 100 psi. Further examples may involve having the cavitation chamber 55 receive the process fluid 100 at a high pressure during operation. The source of the pressure for the process fluid 100 is not particularly limited. In the present example, the process fluid 100 may be pumped into the inlet 60 with a feed pump (not shown). In other examples, the pressure may be from other upstream devices that release the process fluid 100 at a high pressure. Furthermore, the pressure may also be from the pressure of the oil well.

The micro-bubble generator 65 is disposed within the cavitation chamber 55. The micro-bubble generator 65 generates micro-bubbles 110 by reducing the pressure in localized regions of the process fluid 100 as it passes through the micro-bubble generator 65. The pressure in the localized regions is reduced to below the vapor pressure of the process fluid 100. The manner by which the micro-bubble generator 65 reduces localized pressure in regions is not particularly limited.

Once the micro-bubbles 110 form, they leave the localized regions of low pressure and collapse as they return to the higher pressure regions of the process fluid 100. Upon collapsing, the micro-bubbles 110 release localized energy that can facilitate the separation of the components of the process fluid 100 to form a separated fluid 120 which before leaving the cavitation chamber 55. The separated fluid 120 may be moved to another area of the production line for further process, such as a separation chamber (not shown).

Variations of the apparatus 50 are contemplated. As an example, the micro-bubble generator 65, may be modified to be any type of device capable of creating the micro-bubbles 110 that subsequently collapse. Various different designs of reactors may be used dependent on the pressure of the process fluid 100 at the inlet as well as the estimated vapor pressure of the process fluid.

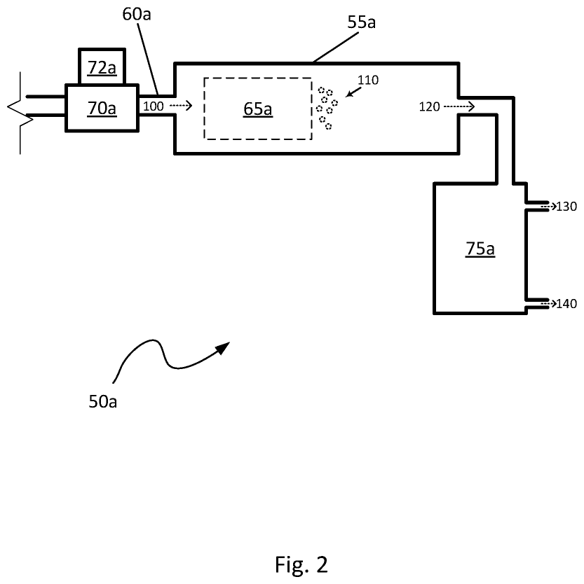

Referring to FIG. 2, another example an apparatus to separate components of a process fluid 100 is generally shown at 50a. Like components of the apparatus 50a bear like reference to their counterparts in the apparatus 50, except followed by the suffix “a”. The apparatus 50a includes a cavitation chamber 55a, an inlet 60a from which the process fluid 100 enters the cavitation chamber 55a, and a micro-bubble generator 65a. In the present example, the apparatus 50a further includes a pump 70a, a flow controller 72a, and a separator 75a.

In the present example, the cavitation chamber 55a and the micro-bubble generator 65a may be substantially similar or identical to the counterparts in the apparatus 50. In particular, the cavitation chamber 55a is to receive a process fluid 100 via the inlet 60a. Micro-bubbles 110 are generated with the micro-bubble generator 65a and the subsequent collapse of the micro-bubbles forms a separated fluid 120.

The present example includes a pump 70a to pump the process fluid 100 through the inlet 60a and into and through the cavitation chamber 55a. The pump 70a is not particularly limited and may be any type of pump capable of pumping oil from a source, such as a production well or from an upstream pre-processing apparatus. In the present example, the pump 70a is a variable frequency drive pump. In other examples, the pump 70a may be a rotary pump, or any other style of pump capable of pumping consistent volumes at a stable pressure.

In the present example, the pump 70a is controlled by a flow controller 72a. The flow controller 72a is to control the flow of process fluid 100 into the cavitation chamber 55a. In particular, the flow controller 72a may be used to control the operation of the pump 70a to maintain a constant pressure at the inlet 60a. The flow controller 72a is not particularly limited and may include a processor connected to sensors at various locations of along a process fluid line. The sensors may provide data to the processor, which in turn can send control signals to control the pump 70a to adjust for pressure variations. The control signals are not limited and may be different depending on the pump 70a. Continuing with the present example where the pump 70a is a variable frequency drive pump, the processor may send commands to control the pump speed depending on the pressure of the process fluid before the pump. The pump speed may be increased or decreased depending on the pressure difference needed. Accordingly, the pump 70a and flow controller 72a may operate together to maintain a fluid pressure at the inlet 60a at a predetermined target pressure. The predetermined target pressure is not particularly limited and may vary from one application to another depending on the composition of the process fluid 100 which may affect the chemical and physical characteristics.

It is to be appreciated by a person of skill in the art with the benefit of this description that the cavitation chamber 55a and the micro-bubble generator 65a are designed to operate within a range of parameters. By maintaining the pressure of the process fluid 100 at the inlet 60a and flow rate at target values or close to the target values, the efficiency of the micro-bubble generator 65a is greater than if the pressure is higher or lower than the target pressure. Therefore, the combination of the pump 70a and the flow controller 72a operate to improve the efficiency of the apparatus 50a.

In other examples, instead of using a processor as the flow controller, a mechanical or analogy replacement of the flow controller 72a may be substituted. The mechanical pressure gauge may be used to measure the pressure of the process fluid on either side of the pump 70a to control the pump speed when threshold values are reached. As another example, of a variation of the apparatus 50a, the pump 70a may be replaced with a mechanical pressure regulator for application where the pressure of the process fluid 100 into the apparatus 50a is greater than the target pressure of the process fluid 100 into the cavitation chamber 55a. In further examples, the apparatus 50a may include both a pump and a pressure regulator to accommodate input pressures that may be over or under the target pressure of the process fluid 100 into the cavitation chamber 55a.

Accordingly, by controlling the pressure of the process fluid 100 into the cavitation chamber 55a, the apparatus 50 may be used in a wide variety of applications that may have varying pressures. For example, the apparatus 50a may be connected to existing upstream treating equipment. In particular, the apparatus 50a may receive process fluid from a tank, with threshold level shut off relays, or it can be at varying feed rates coming directly off the existing production treatment equipment

The separator 75a is to separate the components of the separated fluid 120 leaving the cavitation chamber 55a. In the present example, the separator 75a is a separation vessel to separate a crude oil component 130 from a water component 140 via gravity separation to be extracted from different outlets. Accordingly, the separator 75a is to provide sufficient retention time for the two phases to separate.

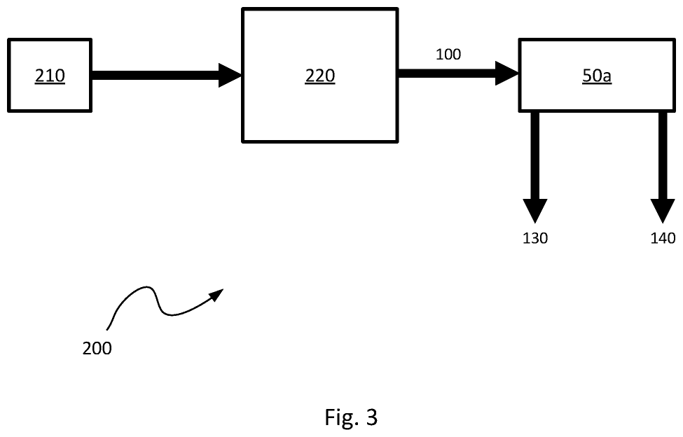

Referring to FIG. 3, an example of a system to produce oil is generally shown at 200. In the present example, the system 200 uses the apparatus 50a described above, but it is to be appreciated that the apparatus 50 may also be used. Furthermore, the system 200 may include additional devices or subsystems used to produce oil, such as pumping equipment, separation systems, storage tanks, and oil recovery enhancement systems. The system 200 includes an oil well 210, a pre-processing system 220 and the apparatus 50a.

In the present example, the oil well 210 is a source of oil. The fluid produced, typically, both and oil and water mixture, from the oil well 210 is not particularly limited and may include hydrocarbons, such as sweet crude, heavy crude, and/or bitumen. The material produced from the oil well 210 may be dependent on the location of the oil well 210 as well as the formation from which the oil well 210 extracts material.

The pre-processing system 220 is not particularly limited. In the present example, the pre-processing system 220 may include various pumps and filters to move and process the material from the oil well 210. For example, the pre-processing system 220 may include subsystems to separate crude oil from the produced mixture include a free water knockout system, a heater treater, a skim tank, or other separation system. The pre-processing system 220 may extract salable crude oil from the produced material from the oil well 210. The salable crude oil may then be separated and stored for sale and transportation to a consumer, such as a refinery.

In further examples, the pre-processing system 220 may include a filtering system to remove sediment and sand from the produced material from the oil well. The filtering system is not particularly limited and may include the separators described above. In addition, the pre-processing system 220 may include a screen or mesh to prevent particles from being further processed. The size of the particles to be filtered is not limited and may depend on the tolerances of the downstream equipment. In an example, a screen may be used to remove particles greater than 0.375 inches. In other examples, the screen may allow larger particles to reduce the probability of clogging the filter and the flow of fluid in the system 200. However, the larger particles may cause additional wearing of downstream equipment, such as the apparatus 50a.

After pre-processing the produced material, the remaining material from the oil well 210 is the process fluid 100. In the present example, the process fluid 100 is delivered to the apparatus 50a which outputs a crude oil component 130 of and a water component 140. It is to be appreciated by a person of skill in the art with the benefit of this description that the water component 140 after processing by the apparatus 50a includes substantially less crude oil than the process fluid 100 which would have typically been discarded, such as into a tailings pond, or reinjected into a well. The crude oil component 130 may be salable crude oil and added to the storage and transportation systems to which the separated oil from the pre-processing system 220 delivers salable crude oil. However, in the event that the crude oil component 130 cannot be further used, the volume of waste would be significantly reduced compare to discarding the process fluid from the pre-processing system 220.

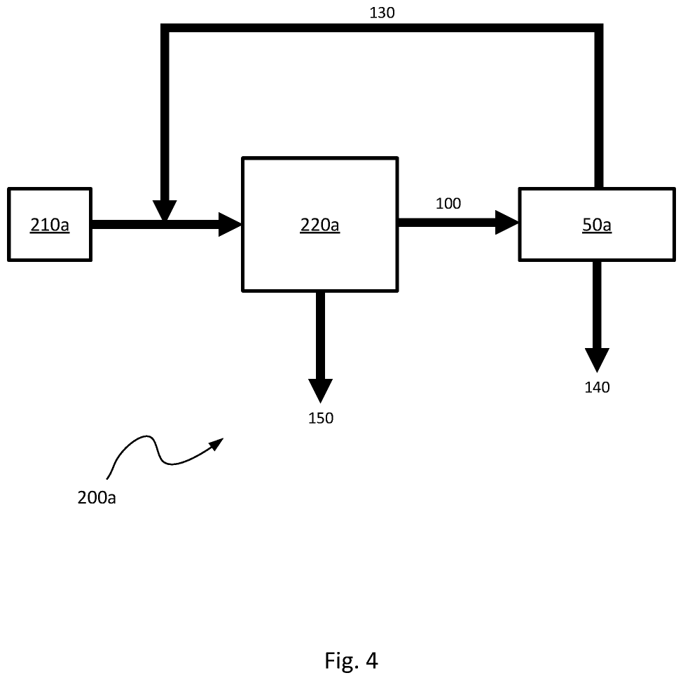

Referring to FIG. 4, an example of a system to produce oil is generally shown at 200a. Like components of the system 200a bear like reference to their counterparts in the system 200, except followed by the suffix “a”. In the present example, the system 200a uses the apparatus 50a described above, but it is to be appreciated that the apparatus 50 may also be used. Furthermore, the system 200a may include additional devices or subsystems used to produce oil, such as pumping equipment, separation systems, storage tanks, and oil recovery enhancement systems. The system 200a includes an oil well 210a, a pre-processing system 220a and the apparatus 50a.

In the present example, the pre-processing system 220a includes various pumps and filters to move and process the material from the oil well 210a. For example, the pre-processing system may include subsystems to separate crude oil from the produced mixture include a free water knockout system, a heater treater, a skim tank, or other separation system. The pre-processing system 220a extracts salable crude oil 150 from the produced material from the oil well 210a. The salable crude oil 150 is stored for sale and transportation to a consumer, such as a refinery.

Furthermore, the crude oil component 130 from the apparatus 50a is to be reintroduced into the stream to be mixed with material produced from the oil well 210a and re-processed by the pre-processing system 220a. Accordingly, the system 200a may be well suited for systems where the apparatus 50a is not able to separate a salable product from the process fluid 100. The crude oil component 130 may be mixed with the material from the oil well 210a and re-processed by the pre-processing system 220a to provide a salable crude oil 150. The process may be iterated continuously such that the only products provided by the system 200a are the water component 140 and salable crude oil 150.

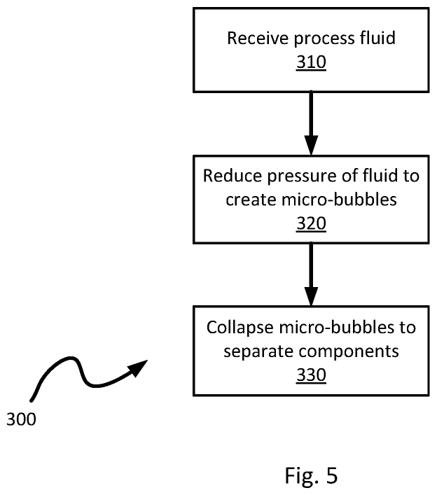

Referring to FIG. 5, a flowchart of an example method of separating components of a process fluid is generally shown at 300. In order to assist in the explanation of method 300, it will be assumed that method 300 may be performed by the apparatus 50. Indeed, the method 300 may be one way in which the apparatus 50 may operate.

Beginning at block 310, the cavitation chamber 55 is to receive a process fluid 100 at a high pressure during operation via the inlet 60. The manner by which process fluid 100 enters the cavitation chamber 55 is not particularly limited and may involve being pumped therein at an inlet pressure. In the present example, the inlet pressure is to be maintained at a substantially constant target pressure. The predetermined target pressure is not particularly limited and may be selected to increase the performance of the micro-bubble generator 65. Since the dimensions of the system are generally fixed, the pressure may be controlled by measuring and controlling the flow rate of process fluid 100 into the cavitation chamber 55.

Next, block 320 comprises reducing the pressure in localized regions of the process fluid 100 as it passes through the micro-bubble generator 65 from the inlet 60 to a pressure that is below the value of the vapor pressure of the process fluid 100. By reducing the pressure below the vapor pressure, micro-bubbles 110 are created in the process fluid 100. The manner by which the micro-bubble generator 65 reduces localized pressure in regions is not particularly limited. In the present example, the micro-bubble generator 65 is a hydrodynamic cavitation reactor having a blade moving at a high speed through the process fluid 100 to create localized regions of low pressure as the blade passes through.

Block 330 comprises collapsing the micro-bubbles 110 as they move away from the region of localized low pressure and return the normal pressure of the process fluid 100. Upon collapsing, the micro-bubbles 110 release localized energy that can facilitate the separation of the components of the process fluid 100 to form a separated fluid 120 which before leaving the cavitation chamber 55.

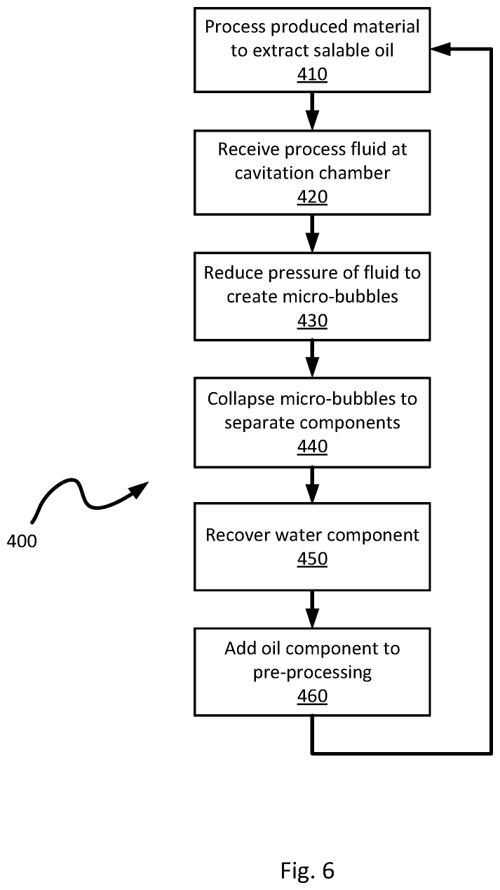

Referring to FIG. 6, a flowchart of an example method of processing produced materials from an oil well is generally shown at 400. In order to assist in the explanation of method 400, it will be assumed that method 400 may be performed by the system 200a. Indeed, the method 300 may be one way in which the system 200a may operate.

Beginning at block 410, produced material from an oil well 210a is processed to extract and recover salable crude oil 150. The manner by which the produced material is processed is not particularly limited and may. For example, the produced material may be processed in a pre-processing system 220a using one or more separators such as a free water knockout system, a heater treater system, a skim tank, or other separation system. After the salable crude oil 150 is removed, the remaining process fluid is delivered to the cavitation chamber 55a for further processing.

At block 420, the cavitation chamber 55a is to receive a process fluid 100 at a high pressure during operation via the inlet 60a. In the present example, the target pressure of the process fluid 100 is maintain using the pump 70a and the flow controller 72a.

Next, block 430 comprises reducing the pressure in localized regions of the process fluid 100 as it passes through the micro-bubble generator 65a to a pressure that is below the value of the vapor pressure of the process fluid 100. By reducing the pressure below the vapor pressure, micro-bubbles 110 are created in the process fluid 100.

Block 440 comprises collapsing the micro-bubbles 110 as they move away from the region of localized low pressure and return the normal pressure of the process fluid 100. Upon collapsing, the micro-bubbles 110 release localized energy that can facilitate the separation of the components of the process fluid 100 to form a separated fluid 120 which before leaving the cavitation chamber 55a to the separator 75a. In the present example, the separator 75a recovers the water component 140 at block 450 and delivers the crude oil component 130 to be re-added into the system at block 460. The crude oil component 130 is to be added to the system prior to the pre-processing block 410 such that crude oil not separated after the first pass through the pre-processing system 220a may be recovered in a second pass as salable crude oil 150.

Various advantages will now be apparent to a person of skill in the art with the benefit of this description. For example, the present examples of separating the crude oil component from the water component of an emulsion use less heat, chemicals and/or mechanical energy including long retention periods for the oil and water liquid phases to separate. Accordingly, the apparatus and methods described herein are capable of breaking emulsions without added heat or chemicals and reduce the retention time required for liquid phase separation, allowing for much higher volumes process fluid to be processed. Furthermore, the physical footprint is relatively small with much lower operating cost compared to existing traditional separation systems, such as setting up a series of cascading storage tank to increase the amount of retention time. By contrast, the apparatus 50 uses one chamber 65 for the accelerated separation and thus has a reduced footprint and capital cost.

It should be recognized that features and aspects of the various examples provided above may be combined into further examples that also fall within the scope of the present disclosure.

1. An method comprising:
receiving a process fluid into a cavitation chamber via an inlet, wherein the process fluid is pumped into the cavitation chamber at an inlet pressure, and wherein the process fluid includes a first component and a second component;
reducing a pressure of the process fluid in the cavitation chamber as the process fluid moves away from the inlet, wherein the pressure is reduced from the inlet pressure to below a fluid vapor pressure to create micro-bubbles; and
collapsing the micro-bubbles to generate a localized energy release, wherein the localized energy release separates the first component from the second component to form a separated fluid.

2. The method of claim 1, further comprising pumping the process fluid into the cavitation chamber.

3. The method of claim 1, wherein the process fluid is an emulsion.

4. The method of claim 3, wherein the first component of the emulsion is water and the second component of the emulsion is oil.

5. The method of claim 1, wherein receiving the process fluid comprises receiving the process fluid from multiple sources.

6. The method of claim 1, wherein the inlet pressure is maintained by controlling a flow rate into the cavitation chamber.

7. The method of claim 1, further comprising separating the separated fluid.

8. The method of claim 7, further comprising dispensing the first component via a first outlet, and dispensing the second component via a second outlet.

9. The method of claim 1, wherein the inlet pressure is at least about 20 psi.

10. The method of claim 9, wherein the inlet pressure is at least about 60 psi.

11. The method of claim 10, wherein the inlet pressure is at least about 100 psi.

12. An apparatus comprising:
a cavitation chamber;
an inlet disposed on the cavitation chamber to receive a process fluid pumped therethrough at an inlet pressure, wherein the process fluid includes a first component and a second component; and
a micro-bubble generator disposed within the cavitation chamber to create micro-bubbles, wherein the micro-bubble generator reduces a pressure of the process fluid below a fluid vapor pressure, and wherein the micro-bubbles collapse to release localized energy to separate the first component from the second component to form a separated fluid.

13. The apparatus of claim 12, further comprising a pump to pump the process fluid through the inlet of the cavitation chamber.

14. The apparatus of claim 12, wherein the process fluid is an emulsion.

15. The apparatus of claim 14, wherein the first component of the emulsion is water and the second component of the emulsion is oil.

16. The apparatus of claim 12, further comprising a flow controller to maintain the inlet pressure.

17. The apparatus of claim 12, further comprising a separator to separate the separated fluid.

18. The apparatus of claim 17, further comprising a first outlet to dispense the first component, and a second outlet to dispense the second component.

19. A system comprising:
an oil well to produce material, wherein the material includes a mixture containing hydrocarbon;
a pre-processor to move and process the material, wherein the pre process pre-processor is to produce process fluid, wherein the process fluid includes a first component and a second component;
a cavitation chamber to receive the process fluid via an inlet at an inlet pressure; and
a micro-bubble generator disposed within the cavitation chamber to create micro-bubbles, wherein the micro-bubble generator reduces a pressure of the process fluid below a fluid vapor pressure, and wherein the micro-bubbles collapse to release localized energy to separate the first component from the second component to form a separated fluid.

20. The system of claim 19, wherein the pre-processor includes a pump to pump the material and the process fluid from the oil well to the cavitation chamber.

21-26. (canceled)
